(19) United States
(12) Patent Application Publication
(10) Pub. No.: US 2009/0201582 A1
(43) Pub. Date: Aug. 13, 2009

(54) Binoculars having center-focusing and individual-focusing functions

(75) Inventor: Chun-Mao Lee, Taipei (TW)

Correspondence Address: BACON & THOMAS, PLLC, 625 SLATERS LANE, FOURTH FLOOR, ALEXANDRIA, VA, 22314-1176, US

(73) Assignee: Foshan City Nanhai Weihong Mold Products Co., Ltd., Foshan City (CN)

(21) Appl. No.: 12/068,689

(22) Filed: Feb. 11, 2008

(51) Int. Cl. G02B 23/00

(52) U.S. Cl. 359/410; 359/399

(57) ABSTRACT

Binoculars having a center-focusing function and an individual-focusing comprise a telescopic base provided at an end thereof with a control sleeve which is connected to a left lens system in a left barrel and a right lens system in a right barrel through an adjusting portion disposed in the telescopic base. When a user pushes the control sleeve so that the control sleeve is forced to shift toward the adjusting portion, the user can rotate the control sleeve to simultaneously actuate the adjusting portion, so as to adjust focuses of the left and right lens systems. When the user pulls the control sleeve so that the control sleeve is forced to shift away from the adjusting portion, the user can rotate the control sleeve to simultaneously actuate the adjusting portion, so as to adjust a parallax between one and the other of the left and right lens systems.

### FIELD OF THE INVENTION

The present invention relates to binoculars, and more particularly to binoculars having center-focusing and individual-focusing functions which can be adjusted directly with a control sleeve.

### BACKGROUND OF THE INVENTION

Traditionally, when a user uses binoculars to view scenery, the usually different eyesights of the user's eyes (i.e. the focus of one eye is different from that of the other eye) may cause a blurry view of the scenery. Furthermore, because the distance between the user and the scenery may be changed in relation to the motion of the user, the user may not clearly view the scenery if the use has moved too far. Therefore, commercially available binoculars generally provide an individual-focusing function and a center-focusing function. The so-called “individual-focusing” function, also know as “parallax adjustment”, means that one barrel of the binoculars can be used to adjust the parallax between one lens system (such as a left lens system) and the other lens system (such as a right lens system), in order to match with the different eyesights of the user' individual eyes. As a result, the use can clearly view the scenery with his/her two eyes looking through the corresponding barrels of the binoculars. Moreover, the so-called “center-focusing” function, also known as “focus adjustment”, means that focuses of the lens systems in the left and right barrels of the binoculars can be simultaneously adjusted with a central-focusing shaft. As a result, the user can clearly view the scenery at various different distances by adjusting the focuses of the lens systems. Thus, the user can use the center-focusing and individual-focusing functions provided by the binoculars to satisfy his/her viewing conditions when using the binoculars.

However, a center-focusing device of binoculars is generally mounted on a central portion of the binoculars, i.e. on a central base formed between a left barrel and a right barrel. Furthermore, an individual-focusing device of the binoculars is generally mounted on the left barrel or the right barrel. Therefore, when manufacturers fabricate binoculars, the center-focusing device must be firstly connected to lens systems in the left and right barrels, and then the individual-focusing device must be connected to one of the lens systems in the left and right barrels. As a result, it may not only complicate the manufacturers' fabricating procedures, but also increase the product's percentage defective. In addition, when a user needs to execute a center-focusing operation (i.e. focus adjustment) and an individual-focusing operation (i.e. parallax adjustment), the user needs to continuously shift from one portion of the binoculars to another for adjustment, making it a troublesome process for the user to adjust, learn, and use the binoculars. Besides, because the individual-focusing device is generally adjacent to an eyepiece of a barrel, the user may easily touch the individual-focusing device while viewing the scenery, so that a parallax range which has been adjusted by the user is off and needs to be re-adjusted, so as to increase the loading of the user in use. Therefore, it is important for manufacturers of binoculars to develop binoculars with a simple structure to facilitate center-focusing and individual-focusing so that it is easy to learn to use the binoculars.

It is therefore tried by the inventor to develop binoculars having center-focusing and individual-focusing functions which can be adjusted directly with a control sleeve, so as to solve the above-mentioned problems associated with conventional binoculars such as complicated assembly procedures, and difficulty in adjustment.

### SUMMARY OF THE INVENTION

A primary object of the present invention is to provide binoculars having center-focusing and individual-focusing functions, which comprise a telescopic base, a left barrel, and a right barrel, wherein the left and right barrels are disposed on a left side and a right side of the telescopic base, respectively. The telescopic base is provided at an end thereof with a control sleeve which is connected to an adjusting portion. The control sleeve includes a first control portion, a second control portion, a center-focusing rod, and an individual-focusing ring, wherein the first and second control portions are connected to the adjusting portion, respectively, while the first control portion can actuate the second control portion through the center-focusing rod or the individual-focusing ring. Furthermore, the adjusting portion is connected to a left lens system in the left barrel and a right lens system in the right barrel, respectively. When the control sleeve is forced to shift toward the adjusting portion, the first control portion is separated from the individual-focusing ring, and engaged with the center-focusing rod. At this time, if the control sleeve is rotated, the control sleeve can actuate the second control portion through the center-focusing rod, so that the second control portion can simultaneously drive the adjusting portion, in order to adjust focuses of the left and right lens systems. On the other hand, when the control sleeve is forced to shift away from the adjusting portion, the first control portion is separated from the center-focusing rod, and engaged with the individual-focusing ring. At this time, if the control sleeve is rotated, the control sleeve can actuate the second control portion through the individual-focusing ring, so that the second control portion can simultaneously actuate the adjusting portion, in order to adjust a parallax between one and the other of the left and right lens systems. As a result, a user can conveniently execute a center-focusing operation and an individual-focusing operation on the binoculars by controlling the displacement and the rotating direction of the control sleeve.

A secondary object of the present invention is to provide binoculars having center-focusing and individual-focusing functions, wherein the center-focusing function and the individual-focusing function are controlled by the control sleeve. As a result, when manufacturers assemble the binoculars, a center-focusing device and an individual-focusing device can be simultaneously assembled, so as to shorten manufacturing time, efficiently increase the yield of products, and lower production cost.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a partially cross-sectional view of binoculars according to a preferred embodiment of the present invention;

FIG. 2 is an exploded perspective view of a control sleeve and an adjusting portion according to the preferred embodiment of the present invention;

FIG. 3 is an exploded perspective view of a first control portion according to the preferred embodiment of the present invention; and

FIG. 4 is an exploded perspective view of a second control portion according to the preferred embodiment of the present invention.

### DETAILED DESCRIPTION OF THE PREFERRED EMBODIMENTS

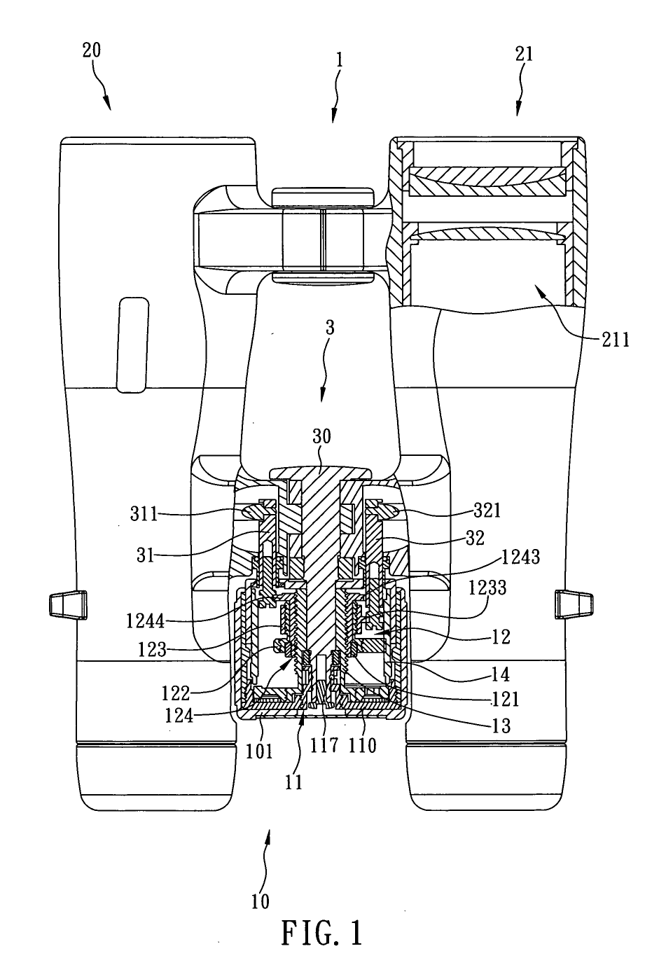

FIG. 1 illustrates binoculars having center-focusing and individual-focusing functions according to a preferred embodiment of the present invention. As shown, the binoculars comprise a telescopic base 1, a left barrel 20, and a right barrel 21, wherein the telescopic base 1 is disposed between the left and right barrels 20, 21. The telescopic base 1 has one end provided with a control sleeve 10 which is connected to a left lens system 211 in the left barrel 20 and a right lens system 211 in the right barrel 21 through an adjusting portion 3 disposed in the telescopic base 1. (Because the left and right lens systems 211 are prior art, only the right lens system 211 is shown in FIG. 1 to avoid complicating FIG. 1.) When a user pushes the control sleeve 10 so that the control sleeve 10 is forced to shift toward the adjusting portion 3 by a predetermined distance, the user can rotate the control sleeve 10 to simultaneously actuate the adjusting portion 3, so as to adjust focuses of the left and right lens systems 211. On the other hand, when the user pulls the control sleeve 10 so that the control sleeve 10 is forced to shift away from the adjusting portion 3 by a predetermined distance, the user can rotate the control sleeve 10 to simultaneously actuate the adjusting portion 3, so as to adjust a parallax between one (such as the left lens system 211) and the other (such as the right lens system 211) of the left and right lens systems 211.

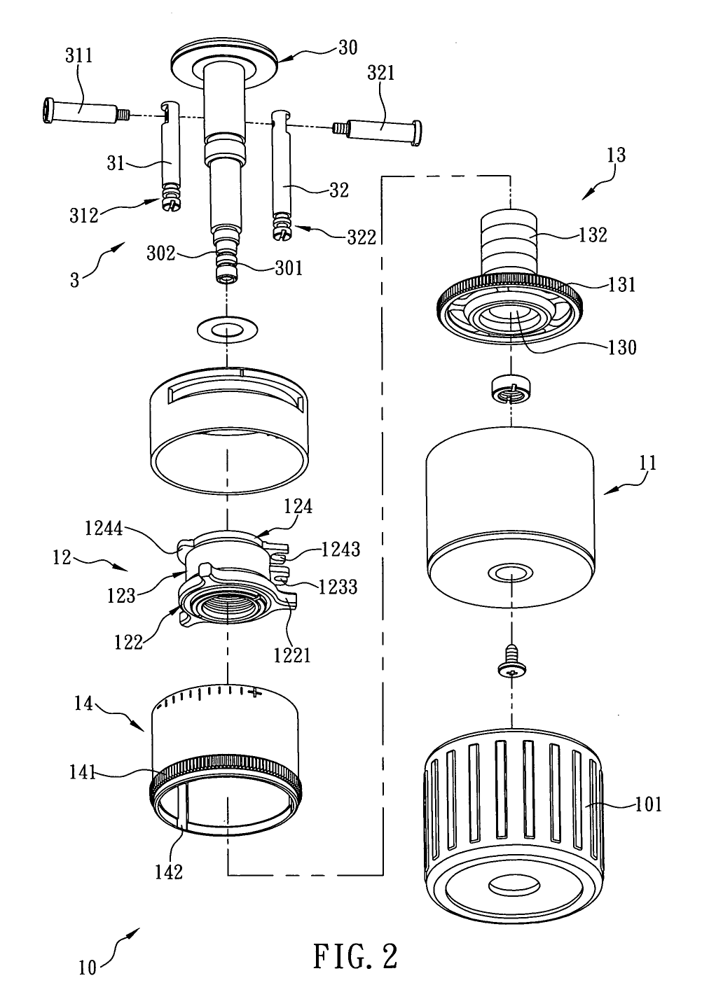

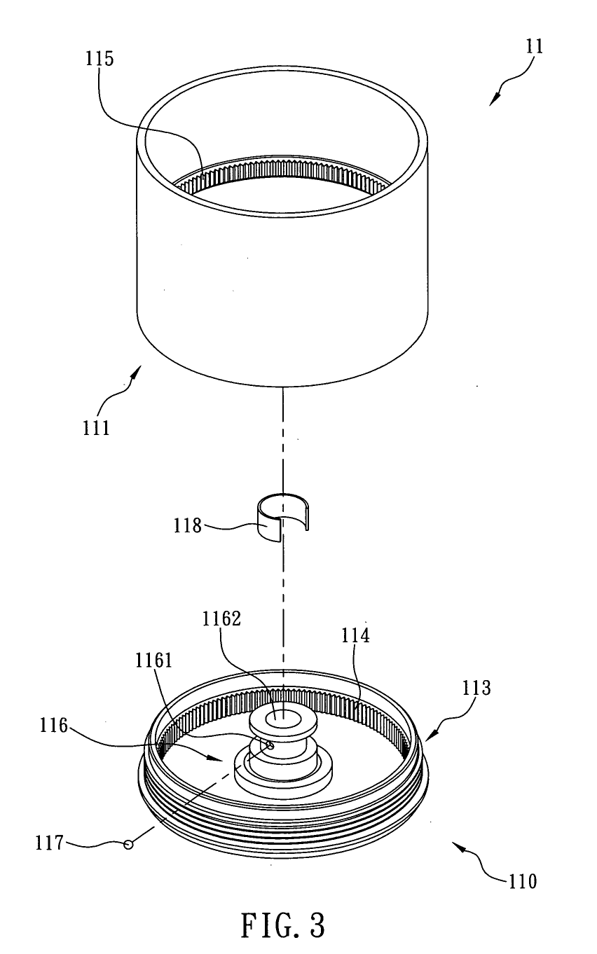

In the preferred embodiment of the present invention, the control sleeve 10 is mounted on the telescopic base 1 and adjacent to eyepieces of the left and right barrels 20, 21 (i.e. a portion of the barrels adjacent to the user's eyes). However, in other preferred embodiments of the present invention, the location of the control sleeve 10 is not limited to the foregoing location, and the control sleeve 10 also can be mounted on a portion of the binocular base 1 distant from the eyepieces (i.e. a portion adjacent to object lenses). If the location of the control sleeve 10 is varied, the direction at which the adjusting portion 3 is located will be correspondingly varied, to ensure that the control sleeve 10 can carry out the center-focusing function and the individual-focusing function of the binoculars. Referring now to FIG. 2, in the preferred embodiment of the present invention, the control sleeve 10 includes a first control portion 11, a second control portion 12, a center-focusing rod 13, and an individual-focusing ring 14, wherein the second control portion 12 is received in the first control portion 11, while the center-focusing rod 13 and the individual-focusing ring 14 are movably disposed between the first control portion 11 and the second control portion 12. Referring now to FIG. 3, in the preferred embodiment of the present invention, the first control portion 11 comprises a center-focusing engagement portion 110 and an individual-focusing engagement portion 111. The center-focusing engagement portion 110 has a surface formed with a flange ring 113. The flange ring 113 has an outer periphery formed with an outer thread for being screw-connected to the individual-focusing engagement portion 111, so that the center-focusing engagement portion 110 and the individual-focusing engagement portion 111 are integrated into one piece. Moreover, the flange ring 113 has an inner periphery formed with a first inner tooth portion 114 for being engaged with a first outer tooth portion 131 formed on an outer periphery of an end of the center-focusing rod 13. Furthermore, the individual-focusing engagement portion 111 has an inner periphery formed with a second inner tooth portion 115 for being engaged with a second outer tooth portion 141 formed on an outer periphery of an end of the individual-focusing ring 14. When the first inner tooth portion 114 is engaged with the first outer tooth portion 131, the second inner tooth portion 115 is not engaged with the second outer tooth portion 141, and vice versa. Therefore, the user can choose to engage the first control portion 11 with the center-focusing rod 13 or with the individual-focusing ring 14 by controlling the displacement of the first control portion 11. In addition, the surface of the center-focusing engagement portion 110 adjacent to the flange ring 113 is further provided with a protruded post 116. The protruded post 116 has a center formed with a cavity 1162, while the protruded post 116 can be inserted into a through hole 130 of the center-focusing rod 13. The protruded post 116 has an outer periphery formed with an opening 1161 which is engaged with a ball 117, wherein a portion of the ball 117 is protruded toward the cavity 1162. The outer periphery of the protruded post 116 is further covered by an elastic member 118 for retaining the ball 117 in the opening 1161, so as to prevent the ball 117 from falling off the opening 1161.

Referring still to FIGS. 2 and 3, in the preferred embodiment of the present invention, the adjusting portion 3 comprises a central shaft 30, a first left adjusting rod 31, a second left adjusting rod 311, a first right adjusting rod 32, and a second right adjusting rod 321, wherein the first left adjusting rod 31 has a first end formed with a left annular recess 312, while the first right adjusting rod 32 has a first end formed with a right annular recess 322. Furthermore, the central shaft 30 has an end which is sequentially passed through the second control portion 12, the individual-focusing ring 14, and the center-focusing rod 13, and inserted into the cavity 1162 of the center-focusing engagement portion 110 of the first control portion 11. Meanwhile, the end of the central shaft 30 is formed on an outer periphery thereof with a first ring recess 301 and a second ring recess 302. When the first inner tooth portion 114 is engaged with the first outer tooth portion 131, the ball 117 is engaged with the second ring recess 302. At this time, if the first control portion 11 is rotated, the ball 117 can be rolled along the second ring recess 302. On the other hand, when the second inner tooth portion 115 is engaged with the second outer tooth portion 141, the ball 117 is engaged with the first ring recess 301. At this time, if the first control portion 11 is rotated, the ball 117 can be rolled along the first ring recess 301. As a result, when the user displaces the control sleeve 10, the user can know if the control sleeve 10 is correctly pulled to a center-focusing position or an individual-focusing position by an impact voice and an impact feel caused by the ball 117 being engaged with the second ring recess 302 or the first ring recess 301.

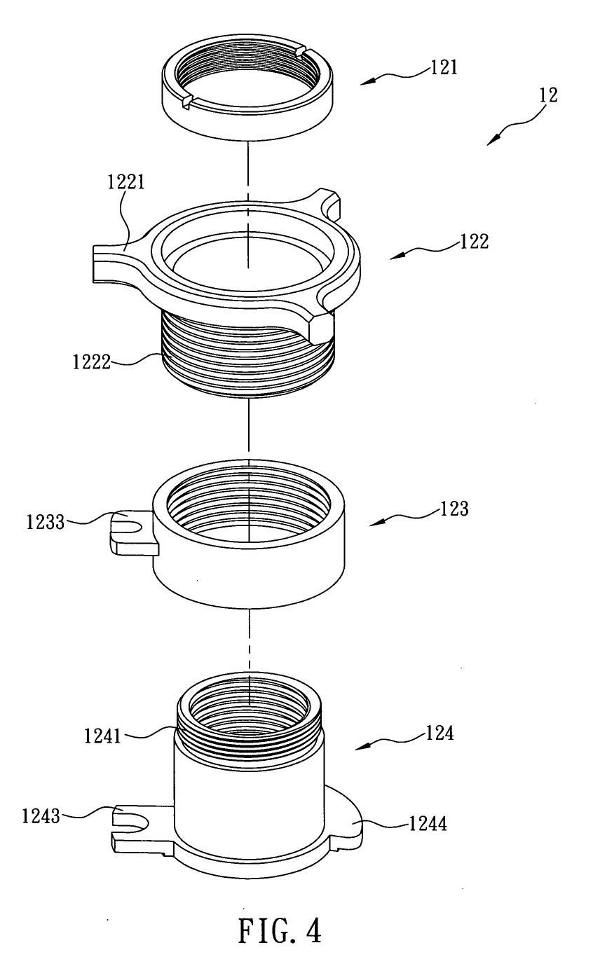

Moreover, referring to FIGS. 2 and 4, in the preferred embodiment of the present invention, the second control portion 12 comprises a positioning thread ring 121, an individual-focusing engagement ring 122, an individual-focusing thread ring 123, and a center-focusing thread ring 124. The individual-focusing engagement ring 122 has a first end with an outer periphery which is formed with three engagement portions 1221. Each of the three engagement portions 1221 can be engaged with a corresponding one of three slots 142 formed on an inner periphery of the individual-focusing ring 14. Thus, when the individual-focusing ring 14 is rotated, it actuates the individual-focusing engagement ring 122 to be rotated. However, in other preferred embodiment of the present invention, the individual-focusing ring 14 and the individual-focusing engagement ring 122 can be correspondingly provided with at least one slot 142 and at least one engagement portion 1221, respectively, wherein the numbers of the slot 142 and of the engagement portion 1221 are not limited to three. In addition, the individual-focusing engagement ring 122 has a second end formed with a first outer thread portion 1222 for being screw-connected to an inner thread portion formed on an inner periphery of the individual-focusing thread ring 123. The individual-focusing thread ring 123 has an outer periphery vertically formed with a first engagement post 1233. The first engagement post 1233 is extended away from the individual-focusing thread ring 123 and connected to the right annular recess 322 of the first right adjusting rod 32, so that the individual-focusing thread ring 123 can only be axially moved. Furthermore, the individual-focusing thread ring 123 is screw-connected to the first outer thread portion 1222 of the individual-focusing engagement ring 122. Therefore, when the individual-focusing ring 14 is rotated, it actuates the individual-focusing engagement ring 122 to be rotated with it, and then the individual-focusing engagement ring 122 actuates the individual-focusing thread ring 123 to be axially moved. Besides, the center-focusing thread ring 124 has a first end with an outer periphery which is formed with a second outer thread portion 1241, and a second end with an outer periphery which is vertically formed with a second engagement post 1243. The second engagement post 1243 is extended away from the center-focusing thread ring 124. When the center-focusing thread ring 124 is passed through the individual-focusing engagement ring 122, the second outer thread portion 1241 can be screw-connected to an inner thread portion formed on an inner periphery of the positioning thread ring 121, so that the center-focusing thread ring 124 and the positioning thread ring 121 are integrated into one piece. At this time, a thread tube 132 protruded from a central portion of the center-focusing rod 13 is passed through a through hole of the second control portion 12, so that an outer thread portion formed on the thread tube 132 is screw-connected to an inner thread portion formed on an inner periphery of the center-focusing thread ring 124. Furthermore, the second engagement post 1243 is engaged with an outer periphery of the first right adjusting rod 32, so that the center-focusing thread ring 124 can only be axially moved and can not be rotated. As a result, when the center-focusing rod 13 is rotated, the center-focusing thread ring 124 will be axially moved at the same time.

Referring back to FIGS. 1 and 2, in the preferred embodiment of the present invention, the center-focusing thread ring 124 is further formed with a protruded engagement block 1244 which is connected to the left annular recess 312 of the first left adjusting rod 31 for actuating the first left adjusting rod 31. Moreover, the first left adjusting rod 31 has a second end away from the protruded engagement block 1244, wherein the second end is connected to a first end of the second left adjusting rod 311. The second left adjusting rod 311 has a second end connected to the left lens system 211 in the left barrel 20. Similarly, the first right adjusting rod 32 has a second end away from the first engagement post 1233, wherein the second end is connected to a first end of the second right adjusting rod 321. The second right adjusting rod 321 has a second end connected to the right lens system 211 in the right barrel 21. As a result, the user can adjust the focuses and the parallax of the right and left lens system 211 by controlling the displacement of the first engagement post 1233 and the protruded engagement block 1244 of the second control portion 12.

Referring back to FIGS. 1, 2, and 3, in the preferred embodiment of the present invention, when the user wants to adjust the focus of the binoculars, the user can exert a force onto the control sleeve 10, so that the control sleeve 10 is forced to shift toward the adjusting portion 3 by a predetermined distance, while the first inner tooth portion 114 of the center-focusing engagement portion 110 is engaged with the first outer tooth portion 131 of the center-focusing rod 13. At this time, the ball 117 is engaged with the second ring recess 302. If the control sleeve 10 is rotated, it actuates the center-focusing rod 13 to be rotated, and then the center-focusing rod 13 actuates the center-focusing thread ring 124 to be axially moved. Because the individual-focusing engagement ring 122 is sleeved on the center-focusing thread ring 124 and the individual-focusing thread ring 123 is screw-connected to the individual-focusing engagement ring 122, the center-focusing thread ring 124, when axially moved, simultaneously actuates the first engagement post 1233 and the protruded engagement block 1244 which then actuates the first left adjusting rod 31 and the first right adjusting rod 32. Finally, the first left adjusting rod 31 and the first right adjusting rod 32 can actuate the second left adjusting rod 311 and the second right adjusting rod 321 to adjust the left and right lens systems 211. As a result, the user can adjust the focus of the binoculars by controlling the control sleeve 10.

Moreover, referring back to FIGS. 1, 2, and 3, in the preferred embodiment of the present invention, when the user wants to adjust the parallax of the binoculars, the user can exert a force onto the control sleeve 10, so that the control sleeve 10 is forced to shift away from the adjusting portion 3 by a predetermined distance, while the second inner tooth portion 115 of the individual-focusing engagement portion 111 is engaged with the second outer tooth portion 141 of the individual-focusing ring 14. At this time, the ball 117 is engaged with the first ring recess 301. If the control sleeve 10 is rotated, it actuates the individual-focusing ring 14 to be rotated, and then the individual-focusing ring 14 actuates the individual-focusing engagement ring 122 to be rotated. Because the individual-focusing thread ring 123 is screw-connected to the individual-focusing engagement ring 122, the individual-focusing thread ring 123, when rotated, will in turn actuate the first engagement post 1233 to be axially moved, so that the first engagement post 1233 actuates the first right adjusting rod 32. Finally, the first right adjusting rod 32 can actuate the second right adjusting rod 321 to adjust the right lens system 211. As a result, the user can adjust the parallax between the right lens system 211 and the left lens system 211 by controlling the control sleeve 10.

Referring still to FIGS. 1 and 2, it should be noted that the control sleeve 10 further comprises an outer sleeve body 101 sleeved on an outer periphery of the first control portion 11, so that it is more convenient for the user to shift and rotate the control sleeve 10. As a result, the user can conveniently adjust the focuses and the parallax of the left and right lens systems 211 in the left and right barrels 20, 21 of the binoculars by controlling the displacement and the rotation direction of the control sleeve 10. Furthermore, the first engagement post 1233 and the protruded engagement block 1244 can alternatively be connected to the first left adjusting rod 31 and the first right adjusting rod 32, respectively, provided that the adjusting portion 3 can only be used to adjust one of the left and right lens systems 211 when the user moves the control sleeve 10 to the individual-focusing position.

The present invention has been described with a preferred embodiment thereof and it is understood that many changes and modifications to the described embodiment can be carried out without departing from the scope and the spirit of the invention that is intended to be limited only by the appended claims.

What is claimed is:

1. Binoculars having center-focusing and individual-focusing functions, comprising:
a telescopic base;
a left barrel disposed on a left side of the telescopic base and having a left lens system therein;
a right barrel disposed on a right side of the telescopic base and having a right lens system therein;
an adjusting portion disposed in the telescopic base and connected to the left lens system in the left barrel and the right lens system in the right barrel, respectively; and
a control sleeve provided at an end of the telescopic base and comprising a first control portion, a second control portion, a center-focusing rod, and an individual-focusing ring;
wherein the first control portion can actuate the second control portion through the center-focusing rod or the individual-focusing ring, so that the second control portion can actuate the adjusting portion; when the control sleeve is forced to shift toward the adjusting portion, the first control portion is separated from the individual-focusing ring and engaged with the center-focusing rod, which can actuate the second control portion to drive the adjusting portion, so as to simultaneously adjust focuses of the left and right lens systems; and when the control sleeve is forced to shift away from the adjusting portion, the first control portion is separated from the center-focusing rod and engaged with the individual-focusing ring, which can actuate the second control portion to drive the adjusting portion, so as to adjust a parallax between one and the other of the left and right lens systems.

2. The binoculars of claim 1, wherein:
the first control portion is connected to the adjusting portion, and has an inner periphery formed with a first inner tooth portion and a second inner tooth portion;
the second control portion is received in the first control portion, and has an outer periphery formed with a first engagement post, a second engagement post, and a protruded engagement block, each of which is connected to the adjusting portion, respectively;
the center-focusing rod is movably disposed between the first control portion and the second control portion, and has an end with an outer periphery which is formed with a first outer tooth portion; and
the individual-focusing ring is movably disposed between the first control portion and the second control portion, and has an end with an outer periphery which is formed with a second outer tooth portion; and
wherein, when the control sleeve is forced to shift toward the adjusting portion by a predetermined distance, the first inner tooth portion of the first control portion is engaged with the first outer tooth portion of the center-focusing rod, such that the control sleeve can be rotated to actuate the center-focusing rod, which then drives the first engagement post and the protruded engagement block of the second control portion, in order to adjust the focuses of the left and right lens systems; when the control sleeve is forced to shift away from the adjusting portion by a predetermined distance, the second inner tooth portion of the first control portion is engaged with the second outer tooth portion of the individual-focusing ring, such that the control sleeve can be rotated to actuate the individual-focusing ring, which then drives the first engagement post of the second control portion, in order to adjust the parallax between one and the other of the left and right lens systems.

3. The binoculars of claim 2, wherein the adjusting portion comprises:
a central shaft which can be sequentially passed through the second control portion, the individual-focusing ring, and the center-focusing rod, and connected to the first control portion;
a first left adjusting rod having a first end formed with a left annular recess which is connected to the protruded engagement block;
a second left adjusting rod having a first end connected to a second end of the first left adjusting rod, and further having a second end connected to the left lens system;
a first right adjusting rod having a first end formed with a right annular recess which is connected to the first engagement post, and further having an outer periphery which is connected to the second engagement post; and
a second right adjusting rod having a first end connected to a second end of the first right adjusting rod, and further having a second end connected to the right lens system.

4. The binoculars of claim 3, wherein the first control portion comprises:
an individual-focusing engagement portion having an inner periphery formed with the second inner tooth portion;
a center-focusing engagement portion having a surface formed with a flange ring which has an outer periphery formed with an outer thread for being screw-connected to the individual-focusing engagement portion, so that the center-focusing engagement portion and the individual-focusing engagement portion are integrated into one piece, while the flange ring has an inner periphery formed with the first inner tooth portion;
a protruded post formed on the surface of the center-focusing engagement portion adjacent to the flange ring, and having a center formed with a cavity, wherein the protruded post has an outer periphery formed with an opening;
a ball received in the opening, wherein a portion of the ball is protruded toward the cavity; and
an elastic member covering the outer periphery of the protruded post.

5. The binoculars of claim 4, wherein the second control portion comprises:
a positioning thread ring having an inner periphery formed with an inner thread portion;
an individual-focusing engagement ring having a first end with an outer periphery which is formed with at least one engagement portion, and further having a second end formed with a first outer thread portion;
an individual-focusing thread ring having an inner periphery formed with an inner thread portion for being screw-connected to the first outer thread portion of the individual-focusing engagement ring, wherein the individual-focusing thread ring has an outer periphery vertically formed with the first engagement post; and
a center-focusing thread ring having a first end with an outer periphery which is formed with a second outer thread portion, and further having a second end with an outer periphery which is vertically formed with the second engagement post and the protruded engagement block, wherein the center-focusing thread ring has an inner periphery formed with an inner thread portion;
wherein, when the center-focusing thread ring passes through the individual-focusing engagement ring, the second outer thread portion can be screw-connected to the inner thread portion of the positioning thread ring, so that the center-focusing thread ring and the positioning thread ring are integrated into one piece; and wherein the individual-focusing thread ring is screw-connected to the first outer thread portion of the individual-focusing engagement ring.

6. The binoculars of claim 5, wherein the center-focusing rod has a central portion formed with a thread tube protruded therefrom, and the thread tube is screw-connected to the inner thread portion of the center-focusing thread ring.

7. The binoculars of claim 6, wherein the individual-focusing ring has an inner periphery formed with at least one slot corresponding to the at least one engagement portion of the individual-focusing engagement ring.

8. The binoculars of claim 7, wherein the central shaft has an end with an outer periphery which is formed with a first ring recess and a second ring recess, while the central shaft has an end inserted into the cavity of the center-focusing engagement portion; the ball can be engaged with the second ring recess when the first inner tooth portion is engaged with the first outer tooth portion; and the ball can be engaged with the first ring recess when the second inner tooth portion is engaged with the second outer tooth portion.

9. The binoculars of claim 8, wherein the control sleeve further comprises an outer sleeve body sleeved on an outer periphery of the first control portion.
